(19) United States
(12) Patent Application Publication
(10) Pub. No.: US 2026/0052322 A1
(43) Pub. Date: Feb. 19, 2026

(54) NOISE PROFILE GENERATION METHOD AND NOISE PROFILE GENERATION SYSTEM

(71) Applicant: MEDIATEK INC., Hsin-Chu (TW)

(72) Inventor: Chi-De Chen, Hsinchu City (TW)

(73) Assignee: MEDIATEK INC., Hsin-Chu (TW)

(21) Appl. No.: 18/803,560

(22) Filed: Aug. 13, 2024

(51) Int. Cl. H04N 25/60; G06V 10/60; H04N 9/73

(52) U.S. Cl. CPC H04N 25/60; G06V 10/60; H04N 9/73

(57) ABSTRACT

A noise profile generation method, for generating a noise profile of an image recording device, comprising: (a) capturing a plurality of test images of a test object by using a plurality of test combinations by the image recording device responding to a control command, wherein each of the test combinations comprises a brightness condition and a color temperature; and (b) computing the noise profile according to the test images.

### BACKGROUND

A camera always comprises an ISP (Image Signal Processor) for processing image data sensed by an image sensor to generate images. The ISP may have a noise reduction function to reduce image noise. Also, the parameter of the ISP may be set according to a noise profile such that the ISP may have a better noise reduction function. The noise profile may comprise, for example, noise levels or distributions of the image noise. However, the image noise may vary corresponding to different conditions of the camera. For example, different combinations of lens and image sensors of the camera may cause different image noise. For another example, different ISO values of the camera may cause different image noise. Therefore, it is difficult to compute a proper noise profile.

### SUMMARY

One objective of the present application is to provide a noise profile generation method which can generate a more accurate noise profile.

Another objective of the present application is to provide a noise profile generation system which can generate a more accurate noise profile.

One embodiment of the present application discloses a noise profile generation method, for generating a noise profile of an image recording device, comprising: (a) capturing a plurality of test images of a test object by using a plurality of test combinations by the image recording device responding to a control command, wherein each of the test combinations comprises a brightness condition and a color temperature; and (b) computing the noise profile according to the test images.

In one embodiment, the brightness condition comprises an aperture size of the image recording device. In another embodiment, the brightness condition comprises an exposure time of an image sensor of the image recording device. In still another embodiment, the brightness condition comprises a luminance of light received by an image sensor of the image recording device.

Another embodiment of the present application discloses a noise profile generation system, comprising: an image recording device; a processing circuit, configured to execute at least one program stored in a storage device to perform a noise profile generation method, which comprises following steps: (a) generating a control command to control the image recording device to capture a plurality of test images of a test object by using a plurality of test combinations, wherein each of the test combinations comprises a brightness condition and a color temperature; and (b) computing a noise profile according to the test images.

In one embodiment, the brightness condition comprises an aperture size of the image recording device. In another embodiment, the brightness condition comprises an exposure time of an image sensor of the image recording device. In still another embodiment, the brightness condition comprises a luminance of light received by an image sensor of the image recording device.

Still another embodiment of the present application discloses an image noise reduction method, for reducing image noise of images generated by the image recording device, comprising: (a) capturing a plurality of test images of a test object by using a plurality of test combinations by the image recording device responding to a control command, wherein each of the test combinations comprises a brightness condition and a color temperature; (b) computing a noise profile according to the test images; and (c) setting parameters of the image recording device according to the noise profile, to reduce image noise.

In one embodiment, the brightness condition comprises an aperture size of the image recording device. In another embodiment, the brightness condition comprises an exposure time of an image sensor of the image recording device. In still another embodiment, the brightness condition comprises a luminance of light received by an image sensor of the image recording device.

In one embodiment, the image recording device is a camera, and the step (c) adjusts the parameters of an ISP of the image recording device.

In view of above-mentioned embodiments, a proper noise profile may be acquired by simple steps, to improve the efficiency of noise reduction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a color checker used in the noise profile generation method according to one embodiment of the present application.

FIG. 2, FIG. 3 and FIG. 4 are schematic diagrams illustrating operations of a noise profile generation method according to different embodiments of the present application.

FIG. 5 is a flow chart illustrating a noise profile generation method according to one embodiment of the present application.

FIG. 6 is a block diagram illustrating a noise profile generation system according to one embodiment of the present application.

FIG. 7 is a block diagram illustrating an exemplary image recording device, which is calibrated according to the noise profile generated by the embodiments of the present application.

### DETAILED DESCRIPTION

Several embodiments are provided in following descriptions to explain the concept of the present invention. The method in following descriptions can be performed by programs stored in a non-transitory computer readable recording medium by a processing circuit. The non-transitory computer readable recording medium can be, for example, a hard disk, an optical disc or a memory. Additionally, the term “first”, “second”, “third” in following descriptions are only for the purpose of distinguishing different one elements, and do not mean the sequence of the elements. For example, a first device and a second device only mean these devices can have the same structure but are different devices. Besides, in following embodiment, a camera is used as an example for explaining, but the camera may be replaced by any other image recording device.

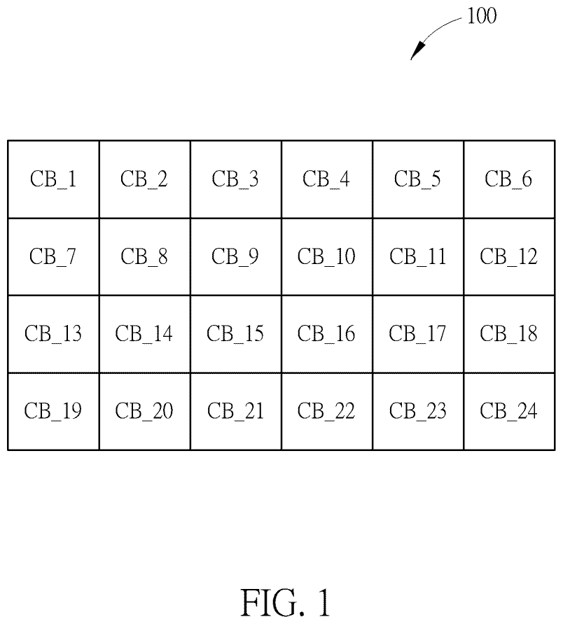

FIG. 1 is a schematic diagram illustrating a color checker 100 used in the noise profile generation method according to one embodiment of the present application. As illustrated in FIG. 1, the color checker 100 has 24 color blocks CB_1 . . . CB_24, which respectively have different colors. Please note, the number of the color blocks may be any other number rather than limited to 24.

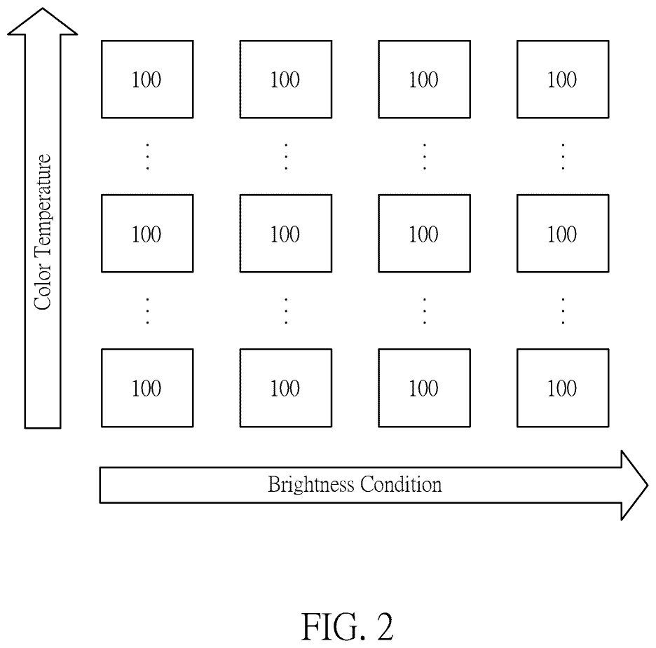

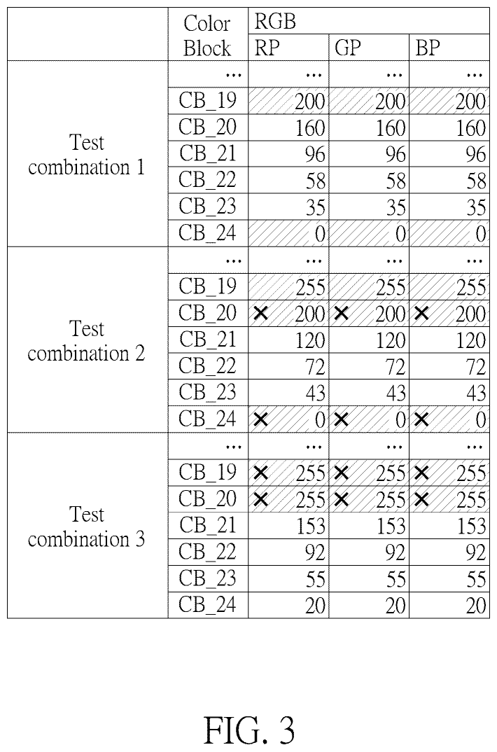

In the embodiment of FIG. 2, a plurality of test images of each one of the color blocks in the color checker 100 are captured by the image recording device using a plurality of test combinations. Each of the test combinations comprises a brightness condition and a color temperature. For example, a test combination 1 comprises a brightness condition 1 and a color temperature 1, and a test combination 2 comprises a brightness condition 2 and a color temperature 2. In such example, a test image 1 of the color block CB_19 is captured using the test combination 1, and a test image 2 of the color block CB_19 is captured for the test combination 2 by using the test combination 2. Such operations may be applied for other color blocks and other test combinations.

The brightness condition may comprise various parameters which may affect the brightness of the test image. In one embodiment, the brightness condition comprises an aperture size of the image recording device. The aperture size is related with the light amount which the image sensor receives. In another embodiment, the brightness condition comprises an exposure time of an image sensor of the image recording device. The exposure time is also related with the light amount which the image sensor receives. In still another embodiment, the brightness condition comprises a luminance of light received by an image sensor of the image recording device.

After the test images are generated, the noise profile is computed according to the test images. The noise profile may comprise noise information for different test combinations and color blocks. For example, noise A may be generated while a test combination X is used for capturing an image of the color block CB_1 by the image recording device, and noise B may be generated while a test combination Y is used for capturing a test image of the color block CB_2 by the image recording device. In one embodiment, the noise profile comprises noise information for image noise in a YUV domain.

In one embodiment, white balances of the test images are adjusted before computing the noise profile. The color of test image may be affected by the color temperature. For example, if the color block has a white color, the test image thereof may become yellow if yellow light (e.g., light with a color temperature about 3000K) is used to emit the color block in the test combination. In such case, if the white balance of the test image is not adjusted to recover the test image to white, wrong noise information may be acquired.

In one embodiment, redundant image data of the test images may be removed to increase the accuracy of the noise profile. For example, in the embodiment of FIG. 3, at least one of redundant pixel values of the test images of different color blocks is removed to generate a plurality of test pixel values. In such case, the noise profile is computed according to the test pixel values. For more detail, in the embodiment of FIG. 3, color blocks CB_19 . . . CB_24 are shown as examples. Further, RP, GP, BP in FIG. 3 respectively represent pixel values of R, G, B pixels of test images of the color blocks CB_19 . . . CB_24 using different test combinations. For example, R, G, B pixel values of the test image of the color block CB_19 using the test combination 1 are respectively 200, 200, 200. For another example, R, G, B pixel values of the test image of the color block CB_21 using the test combination 3 are respectively 153, 153, 153.

As shown in the example of FIG. 3, the test images may have identical R, G, B pixel values, such as the R, G, B pixel values marked by slashes in FIG. 3. Such identical R, G, B pixel values may be caused by extreme pixel values. For example, if the pixel is too bright such that the actual pixel value thereof is over 255, it is still limited to 255. Similarly, if the pixel is very dark such that the actual pixel value thereof is around 0, it may be limited to 0. Besides, such identical R, G, B pixel values may be caused the same or similar colors in different color blocks. Accordingly, in one embodiment, the R, G, B pixel values which occur for more than one time are removed, except the R, G, B pixel values which occur for the first time.

For example, in the embodiment of FIG. 3, R, G, B pixel values (200, 200, 200) occur for the first time for the color block CB_19 using the test combination 1, and occur for the second time for the color block CB_19 using the test combination 2. In such case, the R, G, B pixel values (200, 200, 200) occur for the second time is removed. Following the same rule, other R, G, B pixel values are removed, which are marked by the symbol “X” in FIG. 3. Please note, the step of “removing redundant pixel values” is not limited to the example illustrated in FIG. 3. For example, similar pixel values may also be regarded as redundant pixel values and removed.

As above-mentioned, after the test pixel values are generated, the noise profile is accordingly generated. In one embodiment, the noise profile comprises noises levels for each of the Y, U, V values, as shown in FIG. 4. In one embodiment, only portion of the noise levels are directly generated according to the test images and others are generated by interpolation. For example, the noise levels of the R, G, B pixel values (155, 155, 155) may be acquired by performing interpolation to noise levels of the R, G, B pixel values (160, 160, 160) and (153, 153, 153), which are directly generated according to the test images. The R, G, B pixel values may be transformed to Y, U, V values, thus noise levels of Y, U, V values may be acquired accordingly. In the embodiment of generating noise levels by interpolation, if repeated pixel values are not properly omitted or reduced, a wrong interpolation may be performed thus wrong noise levels may be acquired. Therefore, in the embodiment of generating noise levels by interpolation, the step of removing redundant pixel values is advantage for acquiring a proper noise profile.

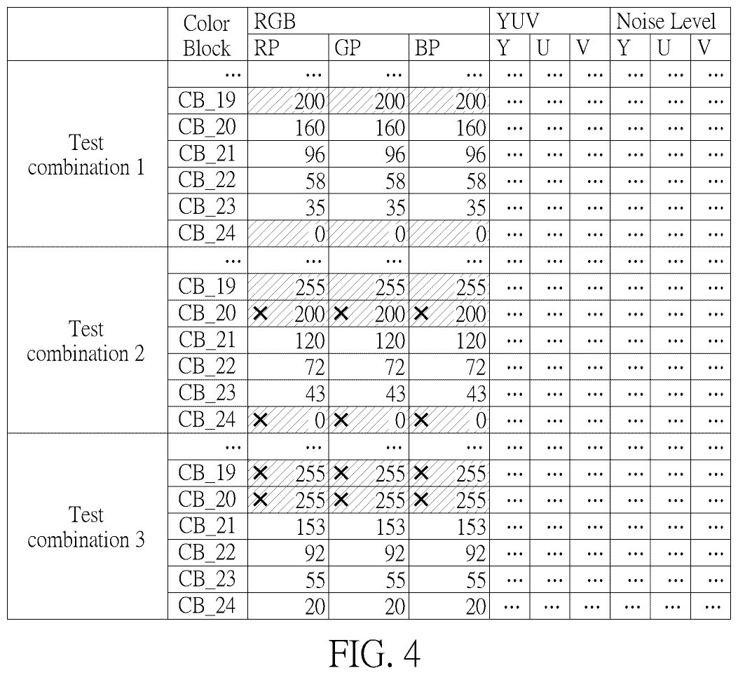

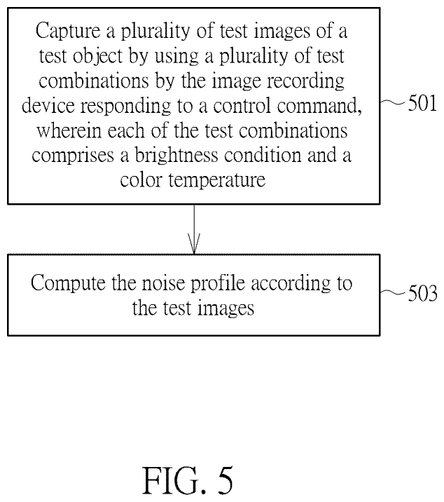

In view of above-mentioned embodiments, a noise profile generation method may be acquired. FIG. 5 is a flow chart illustrating a noise profile generation method according to one embodiment of the present application. As shown in FIG. 5, the noise profile generation method comprises:

### Step 501

Capture a plurality of test images of a test object by using a plurality of test combinations by the image recording device responding to a control command, wherein each of the test combinations comprises a brightness condition and a color temperature.

The test object may be the above-mentioned color block of a color checker 100 illustrated in FIG. 1, but not limited. Further, as above-mentioned, the brightness condition may comprise an aperture size of the image recording device, an exposure time of an image sensor of the image recording device, or a luminance of light received by an image sensor of the image recording device.

### Step 503

Compute the noise profile according to the test images.

If the steps 501, 503 are used for an image noise reduction method, the image noise reduction method may further comprises a step of “setting parameters of the image recording device according to the noise profile, to reduce image noise”. As above-mentioned, the noise reduction may be performed by an ISP of a camera while transforming image data to images, thus the parameters of the ISP may be set according to the noise profile.

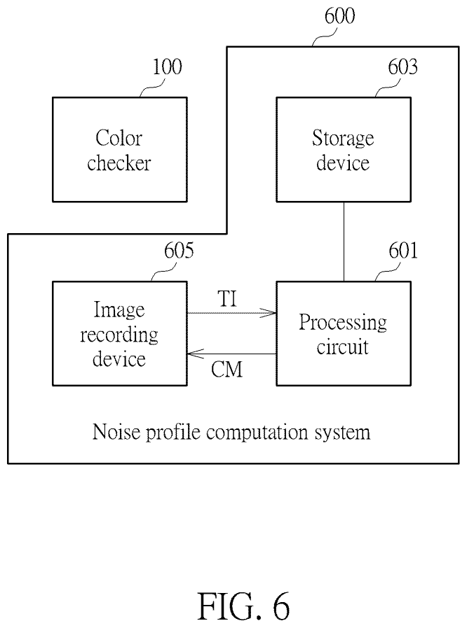

The above-mentioned methods may be applied to a noise profile generation system. FIG. 6 is a block diagram illustrating a noise profile generation system according to one embodiment of the present application. As illustrated in FIG. 6, the noise profile generation system 600 comprises a processing circuit 601, a storage device 603 and an image recording device 605. The noise profile generation system 600 may be provided in a single electronic device, and the storage device 603 may be provided inside or outside the single electronic device.

The processing circuit 601 is configured to execute at least one program stored in a storage device to perform a noise profile generation method, which comprises following steps: (a) generating a control command to control the image recording device to capture a plurality of test images of a test object by using a plurality of test combinations, wherein each of the test combinations comprises a brightness condition and a color temperature; and (b) computing a noise profile according to the test images. In one embodiment, the processing circuit 601 may further perform the step of “setting parameters of the image recording device 605 according to the noise profile, to reduce image noise”. In such case, the noise profile generation system 600 may be regarded as an image noise reduction system.

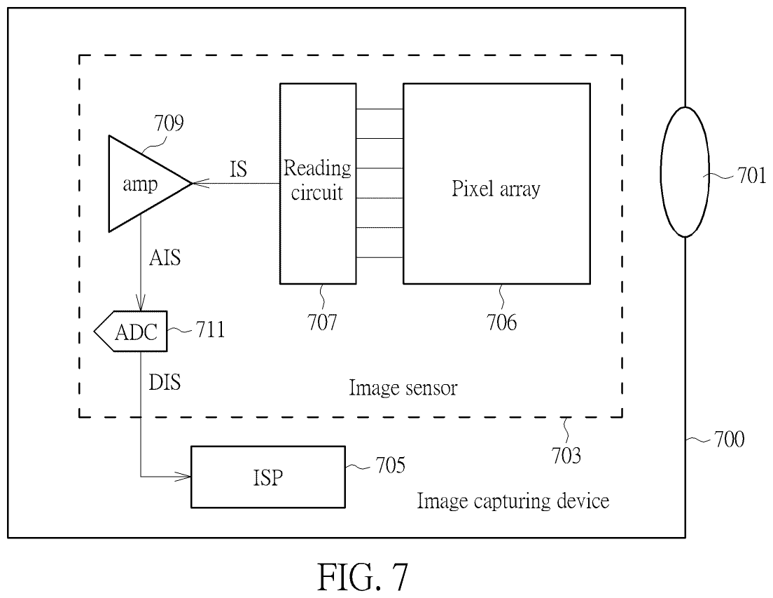

FIG. 7 is a block diagram illustrating an exemplary image recording device, which is calibrated according to the noise profile generated by the embodiments of the present application. In one embodiment, the image capturing device 700 is a camera, and may be an independent electronic device or be integrated to another electronic device such as a mobile phone or a tablet computer.

As shown in FIG. 7, the image capturing device 700 comprises a lens 701, an image sensor 703 and an ISP 705. The image sensor 703 comprises a pixel array 706, a reading circuit 707, an image signal amplifying circuit 709, and an ADC 711. The pixel array 706 comprises a plurality of pixels which generate sensing charges corresponding to the received light passing through the lens 701.

The image signal amplifying circuit 709 is configured to amplify the image signal IS to generate an amplified image signal AIS. The amplified image signal AIS is transmitted to an ADC 711 to generate a digital image signal DIS. The digital image signal DIS is transmitted to the ISP 705, which may generate images according to the digital image signal DIS (i.e., the image data). The ISP 705 may be integrated to the image sensor 703 or independent from the image sensor 703. As above-mentioned, the ISP 705 may perform noise reduction, thus the parameters thereof may be calibrated by above-mentioned embodiments, to improve the noise reduction function thereof.

In view of above-mentioned embodiments, a proper noise profile may be acquired by simple steps, to improve the efficiency of noise reduction.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A noise profile generation method, for generating a noise profile of an image recording device, comprising:
(a) capturing a plurality of test images of a test object by using a plurality of test combinations by the image recording device responding to a control command, wherein each of the test combinations comprises a brightness condition and a color temperature; and
(b) computing the noise profile according to the test images.

2. The noise profile generation method of claim 1, wherein the brightness condition comprises an aperture size of the image recording device.

3. The noise profile generation method of claim 1, wherein the brightness condition comprises an exposure time of an image sensor of the image recording device.

4. The noise profile generation method of claim 1, wherein the brightness condition comprises a luminance of light received by an image sensor of the image recording device.

5. The noise profile generation method of claim 1, wherein the test object is one of color blocks of a color checker, wherein the color blocks have different colors.

6. The noise profile generation method of claim 5, wherein the color checker comprises 24 color blocks.

7. The noise profile generation method of claim 5, further comprising:
removing at least one of redundant pixel values of the test images of different ones of the color blocks to generate a plurality of test pixel values;
wherein the step (b) computes the noise profile according to the test pixel values.

8. The noise profile generation method of claim 1, wherein the noise profile comprises noise information for image noise in a YUV domain.

9. The noise profile generation method of claim 1, further comprising:
adjusting white balances of the test images before the step (b).

10. A noise profile generation system, comprising:
an image recording device;
a processing circuit, configured to execute at least one program stored in a storage device to perform a noise profile generation method, which comprises following steps:
(a) generating a control command to control the image recording device to capture a plurality of test images of a test object by using a plurality of test combinations, wherein each of the test combinations comprises a brightness condition and a color temperature; and
(b) computing a noise profile according to the test images.

11. The noise profile generation system of claim 10, wherein the brightness condition comprises an aperture size of the image recording device.

12. The noise profile generation system of claim 10, wherein the brightness condition comprises an exposure time of an image sensor of the image recording device.

13. The noise profile generation system of claim 10, wherein the brightness condition comprises a luminance of light received by an image sensor of the image recording device.

14. The noise profile generation system of claim 10, wherein the test object is one of color blocks of a color checker, wherein the color blocks have different colors.

15. The noise profile generation system of claim 14, wherein the color checker comprises 24 color blocks.

16. The noise profile generation system of claim 14, further comprising:
removing at least one of redundant pixel values of the test images of different ones of the color blocks to generate a plurality of test pixel values;
wherein the step (b)computes the noise profile according to the test pixel values.

17. The noise profile generation system of claim 10, wherein the noise profile comprises noise information for image noise in a YUV domain.

18. The noise profile generation system of claim 10, further comprising:
adjusting white balances of the test images before the step (b).

19. An image noise reduction method, for reducing image noise of images generated by the image recording device, comprising:
(a) capturing a plurality of test images of a test object by using a plurality of test combinations by the image recording device responding to a control command, wherein each of the test combinations comprises a brightness condition and a color temperature;
(b) computing a noise profile according to the test images; and
(c) setting parameters of the image recording device according to the noise profile, to reduce image noise.

20. The image noise reduction method of claim 19, wherein the image recording device is a camera, and the step (c) adjusts the parameters of an ISP (image signal processor) of the image recording device.
